(19) United States
(12) Patent Application Publication
(10) Pub. No.: US 2012/0223538 A1
(43) Pub. Date: Sep. 6, 2012

(54) ELECTROMAGNETIC GRIPPER COMPRISING A LIGHT SOURCE

(75) Inventor: François Levy, Aix en Provence (FR)

(73) Assignee: CDVI GROUP Societe Anonyme, Pantin (FR)

(21) Appl. No.: 13/509,936

(22) PCT Filed: Mar. 31, 2011
(86) PCT No.: PCT/FR2011/000192

§ 371 Date: May 15, 2012

(30) Foreign Application Priority Data
Apr. 27, 2010 (FR) 10 01786

(51) Int. Cl. B25J 19/00; B25J 15/06

(52) U.S. Cl. 294/65.5

(57) ABSTRACT

The invention relates to an electromagnetic gripper comprising an electromagnet (1) housed in an enclosure consisting mainly of a channel section (2), and a light source, the rays of which exit through an aperture (5) provided in one (2a) of the arms of said channel section, said electromagnetic gripper being characterized in that the aperture through which the light rays exit is blocked by a blade (7) made of translucent material and extending over the entirety or a portion of said flange (2a).

The present invention relates to an electromagnetic gripper comprising a light source.

A gripper is comprised of a prism-shaped electromagnet arranged in an enclosure open on one side to allow contact with the counterplate.

The aforementioned enclosure is formed by a U-shaped channel section, the length of which is greater than that of the electromagnet for housing various electronic components required for proper functioning of the gripper, the space thus provided being closed by a lid. The assembly is completed by end caps, each, in the form of a prism, fitting into the U-shaped channel section and comprising a shoulder that limits penetration in said channel section, in which it is held by screws.

The gripper is generally completed by a low power light source for indicating the electrical state of the gripper.

This source is generally comprised of a light-emitting diode or LED, the light rays of which exit the enclosure through an aperture provided on the flange of the channel section, the end of said LED extending out of said enclosure.

Experience has shown that, regardless of the position of the gripper (whether vertical or horizontal at the upper portion of the door), the light emitted by the LED is not very visible from a distance and requires, in order to be seen by an observer, in particular the monitoring staff, that the latter be positioned substantially in the plane of the partition comprising the gripper.

Added to this is the fact that the aperture provided on the flange of the channel section, the diameter of which is necessarily in the order of several millimeters, promotes undesired acts of vandalism.

The present invention, which overcomes these disadvantages, is characterized in that in that the side comprising the aperture through which the light rays exit is entirely or partially blocked by a blade made of a translucent material capable of conducting the light rays.

In this way, the gripper, for an observer facing the door, appears as a rectangle whose dimensions are substantially equal to those of the flange comprising the blade.

The present invention will be better understood from the following description, with reference to the annexed drawings, provided by way of example only, and in which

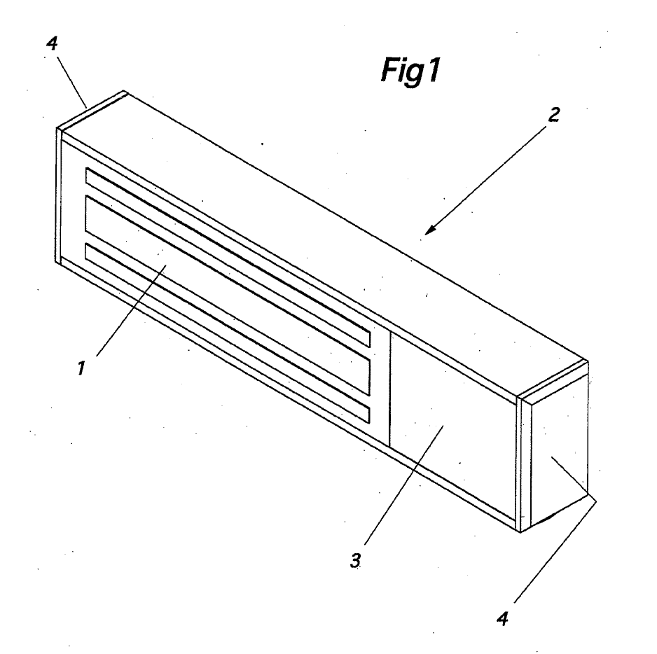

FIG. 1 is a perspective view of a gripper according to the invention;

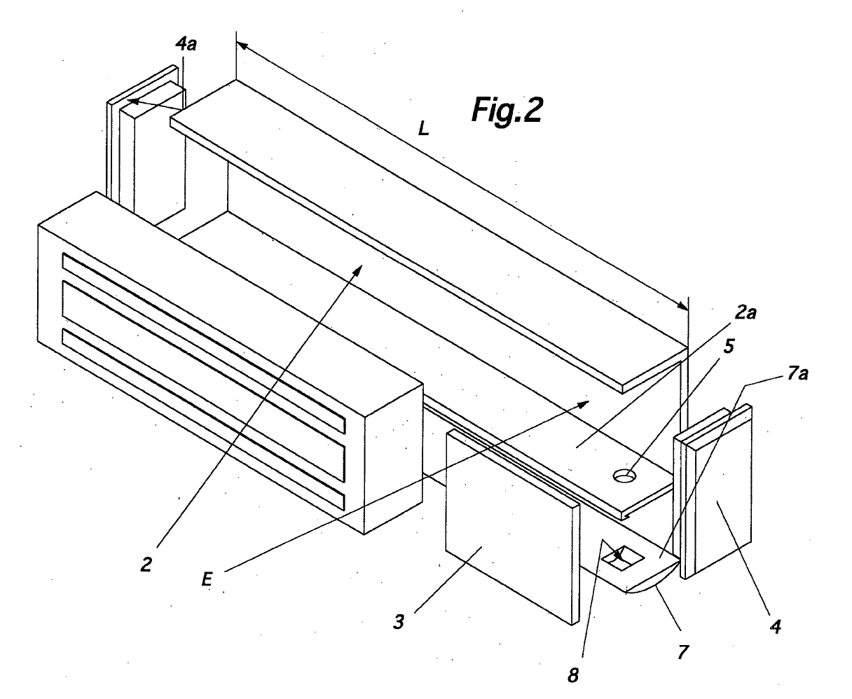

FIG. 2 is an exploded perspective view of the gripper of FIG. 1;

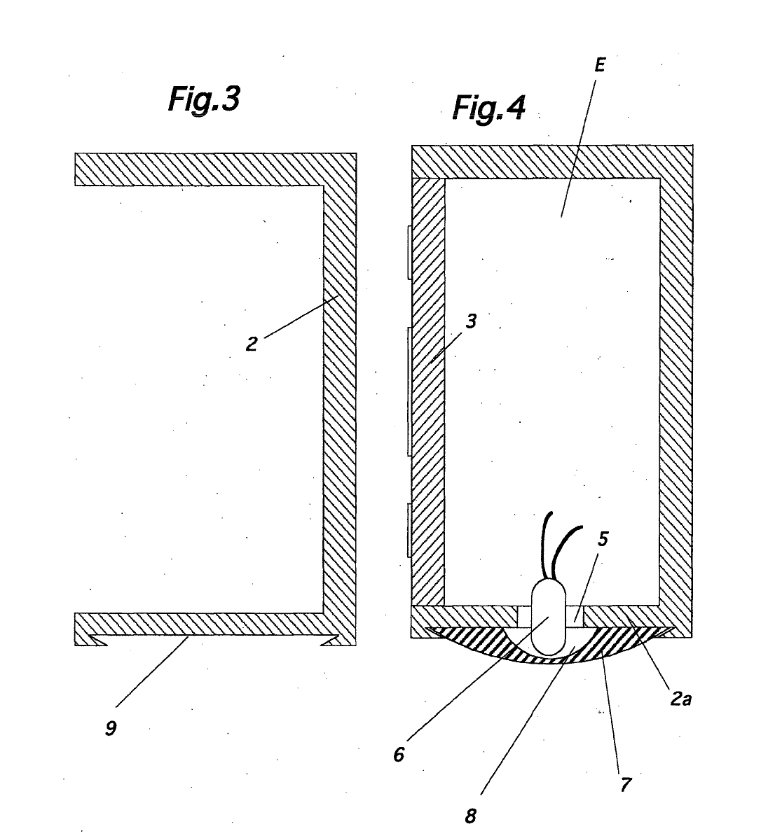

FIG. 3 is a transverse cross-sectional view of a channel section suitable for the implementation of the invention;

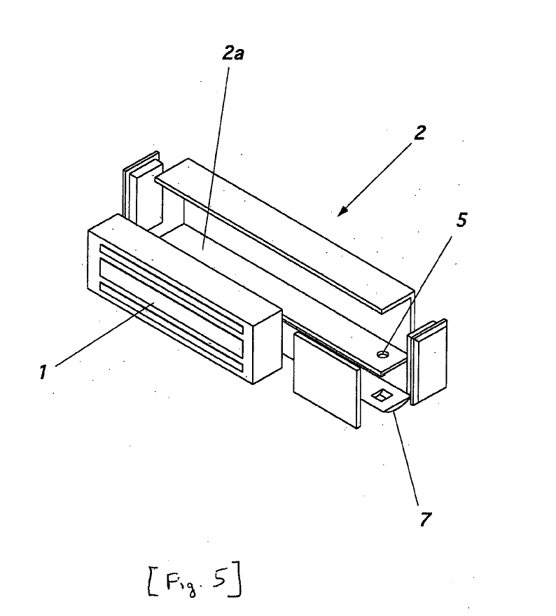

FIG. 4 is a transverse cross-sectional view of the gripper, the cross-section being carried out via a vertical plane passing through the light source.

Referring to the drawings, the electromagnet 1 is shown to be housed, in a known fashion, in an enclosure mainly comprised of a U-shaped channel section 2, the length L of which is greater than that of said electromagnet so as to provide a space E in which the usual electronic components are housed, said space being closed by a trap door 3. The assembly is completed by two end caps 4.

The one 2a of the arms of the channel section 2 has an aperture 5, in the area of the space E, for the exit of the light rays emitted by a light source located in said space.

In the example shown, the light source is comprised of a light emitting diode or LED 6.

According to the invention, the aperture 5 is blocked by a blade 7 extending over the outer surface of the flange 2a. The blade can extend over a portion only of the area of the aforementioned surface.

The blade is made of a translucent material. In this way, when the diode is energized, the blade forms a light guide and the entire corresponding side of the gripper is illuminated.

To promote this effect, the diode 6 extends, beyond the aperture 5, into a housing 8 provided on the hidden surface 7a of the blade.

Preferably, the blade has a cross-section in the shape of a circular segment, the flat surface of which is in contact with the outer surface of the arm 2a.

Various mechanisms can be used to hold the blade, which can be screwed or glued onto the arm 2a.

According to one embodiment, the outer surface of the flange 2a has a longitudinal groove 9, preferably having a dovetail-shaped cross-section, in which the blade is inserted either by longitudinal sliding or by snap-fitting. In both cases, the usual caps 4 can be used for the axial immobilization of the blade, whose ends abut against the shouldered portions 4a.

According to an alternative embodiment, the gripper can have a blade on each of the outer surfaces of the arms of the channel section 2.

1. Electromagnetic gripper comprising an electromagnet (1), housed in an enclosure mainly comprised of a U-shaped channel section (2), and a light source (6), the light rays of which exit through an aperture (5) provided on the one (2a) of the flanges of said channel section, characterized in that the aperture through which the light rays exit is blocked by a blade (7), made of a translucent material and extending over the entirety or a portion of said flange (2a).

2. Gripper according to claim 1, characterized in that the light source extends into a housing (8) provided on the hidden surface (7a) of the blade (7).

3. Gripper according to claim 1, characterized in that the blade, in cross-section, has the shape of a circular segment.

4. Gripper according to claim 1, characterized in that the outer surface of the flange comprising the blade has a longitudinal groove (9) contributing to holding the blade.

5. Gripper according to claim 4, characterized in that the groove (9) has a dovetail-shaped cross-section.
